(19) United States
(12) Patent Application Publication
(10) Pub. No.: US 2006/0195577 A1
(43) Pub. Date: Aug. 31, 2006

(54) Distributed server's failure response program product, server load balancing device, and server load balancing method

(75) Inventor: Isao Tsuji, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 11/133,658

(22) Filed: May 20, 2005

(30) Foreign Application Priority Data
Feb. 25, 2005 (JP) 2005-50408

(51) Int. Cl. G06F 15/173; G06F 15/16

(52) U.S. Cl. 709/226; 709/227

(57) ABSTRACT

In a device according to the present invention, a failed server session persistence information managing unit transfers relevant session persistence information from a session persistence information storing unit to a failed server session persistence information storing unit, upon receipt of a failure detection notice from a distributed server. A session persistence information retrieving unit searches the session persistence information storing unit upon inquiry about session persistence information, and further searches the failed server session persistence information storing unit when information corresponding to the inquiry cannot be extracted from the session persistence information storing unit. A service error response processing unit sends a predetermined service error response to a client when the corresponding information is extracted from the failed server session persistence information storing unit.

### CROSS-REFERENCE TO RELATED APPLICATIONS

This application claims priority from Japanese patent application Serial no. 2005-50408 filed Feb. 25, 2005, the contents of which are herein incorporated by reference.

### BACKGROUND OF THE INVENTION

1. Field of the Invention

This invention relates to a technique of processing for a distributed server's failure response program. In particular, the present invention relates, in a server load balancing process, to a technique of error response processing executed when failure is detected in a distributed server while session persistence is being maintained to ensure the uniqueness of distribution destinations of a session which is composed of a series of requests.

2. Description of the Related Art

FIGS. 7A and 7B are diagrams for explaining server load balancing technology. As shown in FIG. 7A, upon receipt of a series of requests (request A, request B, and request C) from a client 93, the server load balancing device (SLB) 91 in a distribution server system utilizes the server load balancing technology to distribute these requests to distributed servers 92a and 92b, which serve as a distribution destination for executing the requests, according to a predetermined server load balancing definition logic.

There are, however, cases where a series of requests sent from the client 93 as one session must be all processed by one distributed server. Allocating a series of requests within a session uniquely to a particular destination (distributed server), that is, ensuring the uniqueness of request allocations for a client, is termed session persistence maintaining processing.

The server load balancing device 91 has the function for executing this session persistence maintaining processing, and performs the following processing. As shown in FIG. 7B, the server load balancing device 91 receives the first request A of a series of requests sent from the client 93 as one session. Since the first request A is not added with any information about the session persistence maintaining processing (e.g., session identification information), the server load balancing device 91 allocates the request A to the distributed server 92a according to the predetermined server load balancing definition logic. The distributed server 92a sends a process response which is added with, for example, session identification information (SID=1), to the server load balancing device 91.

The server load balancing device 91 determines that this session is to be subjected to the session persistence maintaining processing because the session identification information is set in the received process response to the request A. The server load balancing device 91 then generates and stores session persistence information in accordance with the session identification information (SID=1) and server information of the distribution destination (distribution destination=Server_a), and sends the process response of the request A to the client 93.

The client 93 detects the session identification information that is set in the process request of the request A, sets the session identification information (SID=1) for the request B which is to be sent next, and sends this request B to the server load balancing device 91. The server load balancing device 91 detects the session identification information of the received request B, and allocates this request B to the distributed server 92a by referring to the session persistence information recorded in the server load balancing device 91.

The next request C from the client 93 is processed in the same manner as the above, and is thus allocated to the distributed server 92a on the basis of the session identification information set for the request B. In this manner, the server load balancing device 91 can allocate a series of requests within a session from the client 93 uniquely to the particular distributed device 92a, thereby implementing session persistence to ensure the uniqueness of distribution destination of a session.

While such session persistence is being maintained, a failure may occur in the distributed server 92a which has processed the requests A and B. As shown in FIG. 8, upon detection of a failure in the distributed server 92a, the server load balancing device 91 discards the session persistence information for the failed distributed server 92a by clearing the corresponding area of memory. Therefore, when the server load balancing device 91 receives from the client 93 the request C for which the session persistence needs to be maintained, the server load balancing device 91 cannot retrieve the session identification information regarding the request C from the session persistence information stored therein, and thus cannot determine a distribution destination of the request C. As a result, the server load balancing device 91 determines that the session persistence information is not set for the request C. The server load balancing device 91 consequently allocates this request C to another operative distributed server 92b which is selected as a distribution destination from multiple distribution target servers according to a general load balancing definition logic.

As a technique for ensuring electronic message transmission responsive to a network failure between a WWW browser and a WWW server, there is a known system in which a WWW gateway is provided between a WWW browser and a distribution target WWW server and in which the WWW gateway holds common files containing information of sessions between the WWW browser and WWW server and processing results of the WWW server that are unsent to the WWW browser in order to send the session information of a currently connected session and the unsent processing results in the common files to the WW browser in case of a network failure, so as thereby to ensure transmission of processing results responsive to such a network failure (see the Reference Document 1: Japanese Patent Application Laid-Open No. 2000-90024A, for example).

As described with reference to FIG. 8, however, the following problems arise between the distributed server 92b and the client 93 when the server load balancing device 91 allocates the request C to another distributed server 92b according to the load balancing definition logic because a failure is detected in the distributed server 92a now being used to maintain session persistence.

The request C from the server load balancing device 91 is not expected by the distributed server 92b, and therefore it responds to the client 93 with a sequence error designated for receiving a request abnormality. This causes the distributed server 92b to generate an unnecessary response due to the unexpected receipt of the request C, thus disadvantageously increasing the amount of processing data.

Furthermore, the client 93 which believes that it is executing proper sequences receives the sequence error from the distributed server 92b as a response to the request C, and therefore the client 93 cannot immediately understand the cause meant by this sequence error response, which disadvantageously requires time to investigate this cause of the response.

### SUMMARY OF THE INVENTION

An object of the present invention is to provide a program product for processing a computer program which causes a computer to function as distributed server's failure response means which, in the event of occurrence of failure in a distributed server used to maintain session persistence during server load balancing processing, does not cause unnecessary processing loads on other distributed serves and sends appropriate response notice to a client thereby to eliminate needless investigation works for the cause of the failure.

Another object of the present invention is to provide a server load balancing device which performs processing implemented by the above described program when it is executed, and to provide a server load balancing method.

In order to achieve these objects, the present invention proposes a recording medium having recorded therein a program for causing a computer to function as, during server load balancing processing for distributing client's requests to distributed servers operable as a distribution destination, processing means for executing session persistence maintaining processing to allocate a series of requests within a session uniquely to a particular distributed server and responding to a failure in a distributed server associated with a session being subjected to the session persistence maintaining processing. This recorded program comprises the steps of: 1) causing the computer to function as failed server session persistence information management means for, upon receipt of a distributed server's failure detection notice, extracting and deleting, from session persistence information storage means that stores session persistence information in which a session to be subjected to the session persistence maintaining processing and a distributed server allocated with the session are recorded, session persistence information of a session handled by the notified failed distributed server, then generating failed server session persistence information in accordance with the extracted session persistence information, and storing the generated failed server session persistence information in failed server session persistence information storage means; 2) causing the computer to function as failed server session persistence information retrieval means for, upon receipt of an inquiry request as to whether a session is subjected to the session persistence maintaining processing, retrieving session persistence information of the inquired session from the session persistence information storage means, and further retrieving failed server session persistence information of the inquired session from the failed server session persistence information storage means when the session persistence information of the inquired session is not stored in the session persistence information storage means; and 3) causing the computer to function as service error response processing means for executing predetermined service error response processing for a requester client of the inquired session when the failed server session persistence information of the inquired session is extracted as a result of the retrieval of the failed server session persistence information retrieval means.

According to the present invention, the following processing is executed when a server load balancing device performs the session persistence maintaining processing for allocating a series of requests within a session uniquely to a particular distributed server.

In a device according to the present invention, the session persistence information is stored in which a session to be subjected to the session persistence maintaining processing and a distributed server allocated with this session are set.

Upon receipt of failure detection notice from one of distributed servers operable as a distribution destination, session persistence information of a session handled by the notified failed distributed server is extracted from the session persistence information storage means. Then failed server session persistence information in accordance with the extracted session persistence information is generated and stored in the failed server session persistence information storage means.

Later on, upon receipt of an inquiry request as to whether a session is to be subjected to the session persistence maintaining processing, session persistence information of the inquired session is retrieved from the session persistence information storage means. When the session persistence information of the inquired session is not stored in the session persistence information storage means, failed server session persistence information of the inquired session is retrieved from the failed server session persistence information storage means.

When the failed server session persistence information of the inquired session is extracted as a result of the retrieval of the failed server session persistence information retrieval means, a predetermined error response indicative of a service error is sent to a requester client of the inquired session.

According to the present invention, this requester client can recognize that the service error has occurred while session persistence is maintained. Therefore, unlike the conventional cases, the client no longer needs to perform investigation works for the cause of the error due to the receipt of a sequence error which does not reflect the actual circumstance.

Furthermore, according to the present invention, service error response processing definition information storage means is provided which stores in advance service error response processing definition information that defines, for each service executed in a session between a distributed server and a client, the details of service error response processing for a distributed server's failure caused during the session persistence maintaining processing for the session. When the session persistence information contains at least information for identifying a service executed in a session, the failed server session persistence information containing the information for identifying a service in accordance with that session persistence information can be generated. When the failed server session persistence information of the inquired session is extracted, the service error response processing can be performed in accordance with the service error response processing definition information corresponding to the service identified by the failed server session persistence information.

Accordingly, the appropriate error response processing which corresponds to a service of the session handled by the failed distributed server can be executed in accordance with the service error response processing definition information stored in advance.

Moreover, according to the present invention, there is provided a server load balancing device comprising processing means implemented by executing the above program, and a server load balancing method comprising the steps of performing processing implemented by executing the above program.

### BRIEF DESCRIPTION OF THE DRAWINGS

FIG. 1 is a diagram showing a configuration example according to a preferred embodiment of the present invention;

FIGS. 2A and 2B are diagrams showing an example of session persistence information;

FIGS. 3A and 3B are diagrams showing an example of failed server session persistence information;

FIG. 4 is a diagram showing an example of service error response processing definition information;

FIG. 5 is a flowchart of processing performed upon notice of failure detection;

FIG. 6 is a flowchart of processing performed upon inquiry about the session persistence information;

FIGS. 7A and 7B are explanatory diagrams of server load balancing processing; and

FIG. 8 is a diagram for explaining a problem caused by failure in a distributed server during session persistence maintaining processing.

### DETAILED DESCRIPTION OF THE PREFERRED EMBODIMENTS

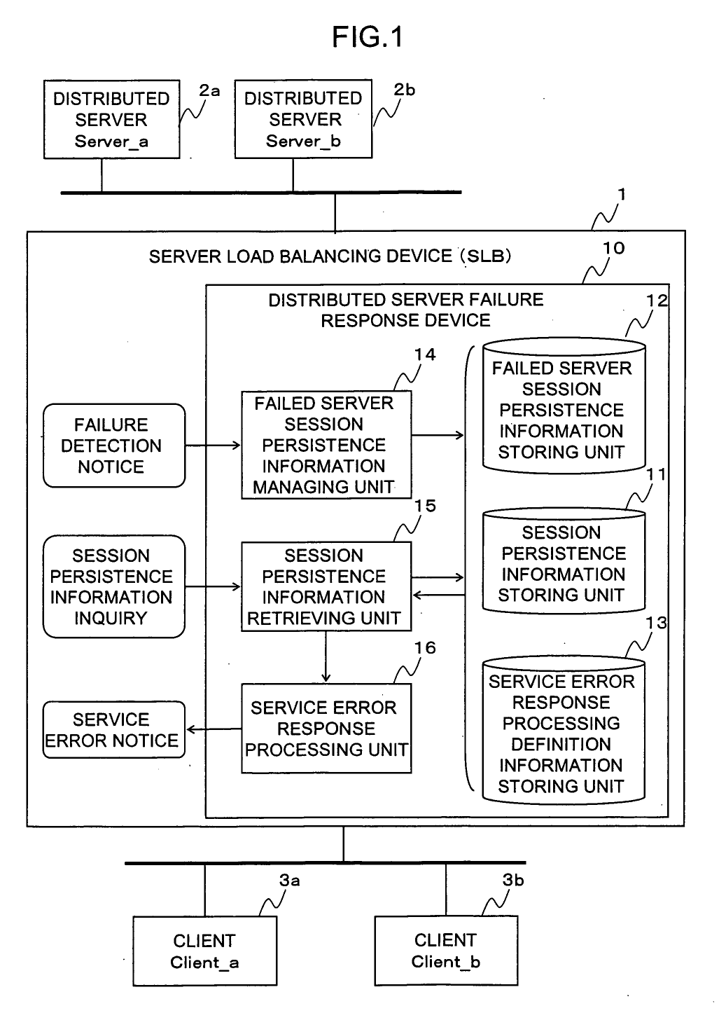

FIG. 1 is a diagram showing a configuration example in a preferred embodiment of the present invention. A distributed server failure response device 10 according to the present invention is implemented as a program embedded in a server load balancing device (SLB) 1.

The server load balancing device (SLB) 1 is a processing device which distributes requests from clients 3 (3a, 3b) among distributed servers 2 (2a, 2b) according to a predetermined server load balancing definition logic and which executes session persistence maintaining processing for allocating a series of requests within a session from the client 3a uniquely to the particular distributed server 2a. The distributed server failure response device 10 comprises a session persistence information storing unit 11, a failed server session persistence information storing unit 12, a service error response processing definition information storing unit 13, a failed server session persistence information managing unit 14, a session persistence information retrieving unit 15, and a service error response processing unit 16.

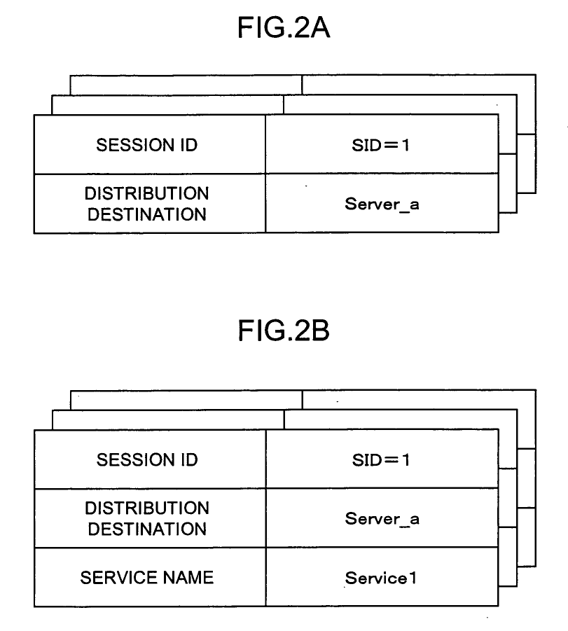

The session persistence information storing unit 11 stores session persistence information for which a session to be subjected to the session persistence maintaining processing and a distributed server 2 allocated with this session are set. FIGS. 2A and 2B show examples of the session persistence information. The session persistence information shown in FIG. 2A is composed of data items such as a session ID (e.g., SID=1) for identifying a session which is established between the client 3a and the distributed server 2a and which is to be subjected to the session persistence maintaining processing, and a distribution destination (e.g., Server_a) for identifying a distributed server to which requests in the persistent session are allocated. The session ID is expressed, for example, by a value which is set by the distributed server 2a having executed the request, and the distribution destination is expressed by an IP address of the distributed server 2a.

Furthermore, as shown in FIG. 2B, the session persistence information may be so designed as to contain as a data item, a service name (e.g., Service1) for identifying a service executed in the session. The service name is set depending on the type of service, such as http communication, ftp communication, and SMTP communication.

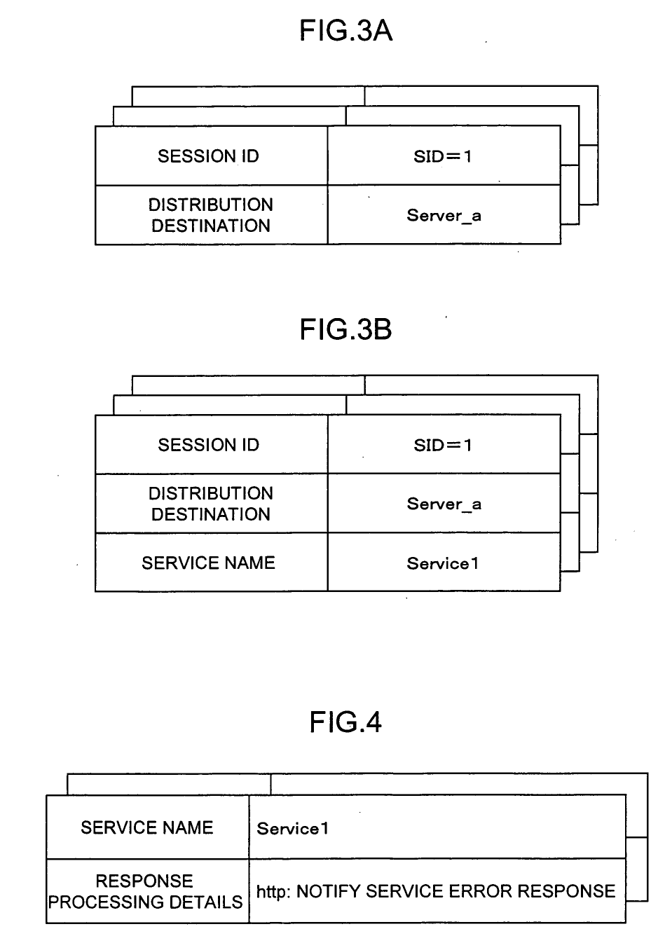

The failed server session persistence information storing unit 12 stores failed server session persistence information about a session which is handled by the failed distributed server 2a and which is now subjected to the session persistence maintaining processing. FIGS. 3A and 3B show examples of the failed server session persistence information. As shown in FIG. 3A, the failed server session persistence information is composed of data items such as a session ID (e.g., SID=1) for identifying a session which is to be subjected to the session persistence maintaining processing, and a distribution destination (e.g., Server_a) for identifying a distributed server allocated with this session. Furthermore, as shown in FIG. 3B, the failed server session persistence information may be so designed as to contain as a data item, a service name (e.g., Service1) for identifying a service executed in the session.

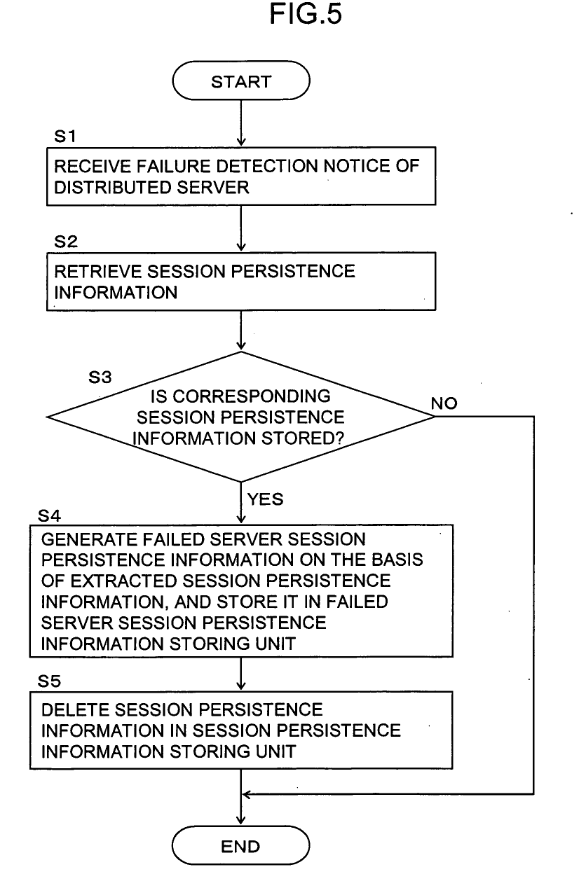

The service error response processing definition information storing unit 13 stores service error response processing definition information which defines, for each service, response processing for failure detection notice of the distributed server that handles the session in the session persistence maintaining processing. FIG. 4 shows an example of the service error response processing definition information. This service error response processing definition information is composed of data items such as a service name (e.g., Service1) for identifying a service executed by the failed distributed server 2a, and response processing details (e.g., service error response notice) that define the details of the error response processing. The response processing details may contain information defining a format, a response method, and the like, of a response message.

Upon receipt of the failure detection notice of the distributed server 2a, the failed server session persistence information managing unit 14 extracts the session persistence information of the session handled by the notified failed distributed server from the session persistence information storing unit 11, then generates failed server session persistence information on the basis of the extracted session persistence information to store the generated failed server session persistence information in the failed server session persistence information storing unit 12, and deletes the extracted session persistence information from the session persistence information storing unit 11. Furthermore, when the session persistence information contains at least information identifying a service name, the failed server session persistence information managing unit 14 can generate failed server session persistence information containing the service name in accordance with this session persistence information.

Upon receipt of an inquiry request as to whether a session is to be subjected to the session persistence maintaining processing, the session persistence information retrieving unit 15 retrieves the session persistence information of the inquired session from the session persistence information storing unit 11, and when the session persistence information of the inquired session is not stored in the session persistence information storing unit 11, the session persistence information retrieving unit 15 retrieves failed server session persistence information of the inquired session from the failed server session persistence information storing unit 12.

When the failed server session persistence information of the inquired session is extracted from the failed server session persistence information storing unit 12 as a result of the retrieval of the session persistence information retrieving unit 15, the service error response processing unit 16 generates a predetermined service error response and sends it to the requestor client 3a of the inquired session. When the extracted failed server session persistence information contains a service name, the service error response processing unit 16 extracts from the service error response processing definition information storing unit 13, the response processing details of the service error response processing definition information which corresponds to the service name contained in the extracted failed server session persistence information, and then executes error response processing according to the extracted response processing details. The service error response processing definition information is not necessary as a component when the service name is not contained in the session persistence information and the failed server session persistence information as shown in FIG. 2A and FIG. 3A, respectively. In this case, the service error response processing unit 16 generates a predetermined service error response and notifies the client 3a of this error response as predetermined service response processing.

FIG. 5 shows a flow of processing performed upon receipt of the failure detection notice. Prior to this processing, the distributed server failure response device 10 stores the session persistence information of a session to be subjected to the session persistence maintaining processing in the session persistence information storing unit 11, and further stores the service error response processing definition information in the service error response processing definition information storing unit 13.

When the server load balancing device 1 detects a failure in the distributed server 2a, and notifies the distributed server failure response device 10 of the failure detection in the distributed server 2a, the failed server session persistence information managing unit 14 receives the failure detection notice of the distributed server 2a (step S1). The failed server session persistence information managing unit 14 searches the session persistence information storing unit 11 (step S2) to determine whether the session persistence information corresponding to the failed distributed server 2a is stored in the session persistence information storing unit 11 (step S3). When the corresponding session persistence information is retrieved (YES in step S3), the server session persistence information managing unit 14 generates failed server session persistence information on the basis of the retrieved server session persistence information of the distributed server 2a, and stores it in the failed server session persistence information storing unit 12 (step S4). Furthermore, the server session persistence information managing unit 14 deletes the retrieved session persistence information from the session persistence information storing unit 11 (step S5). On the other hand, when the corresponding session persistence information is not retrieved (NO in step S3), the processing is terminated.

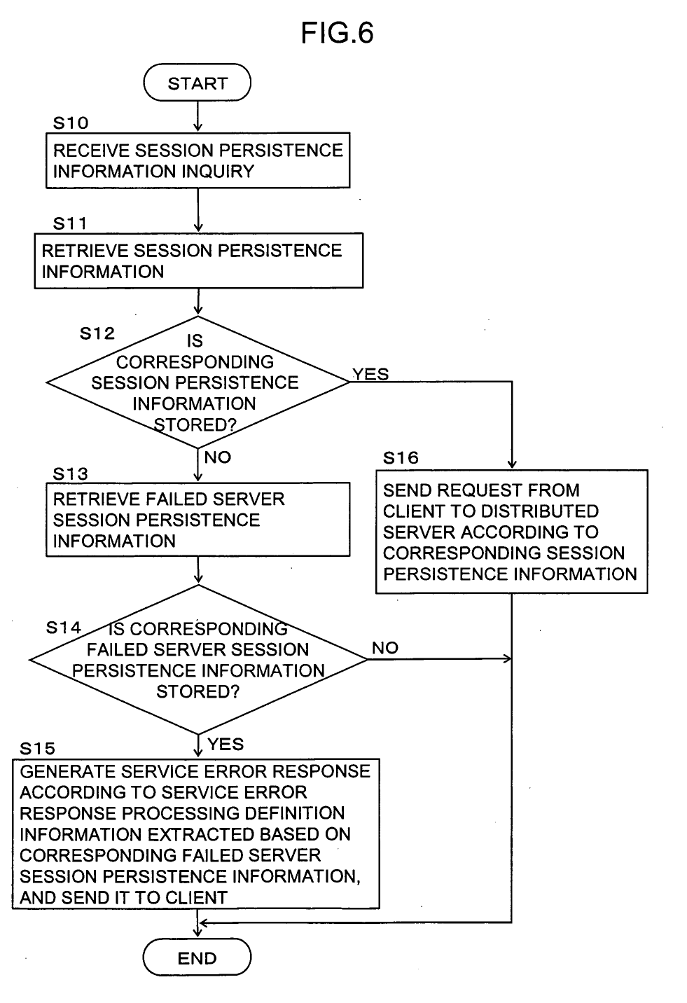

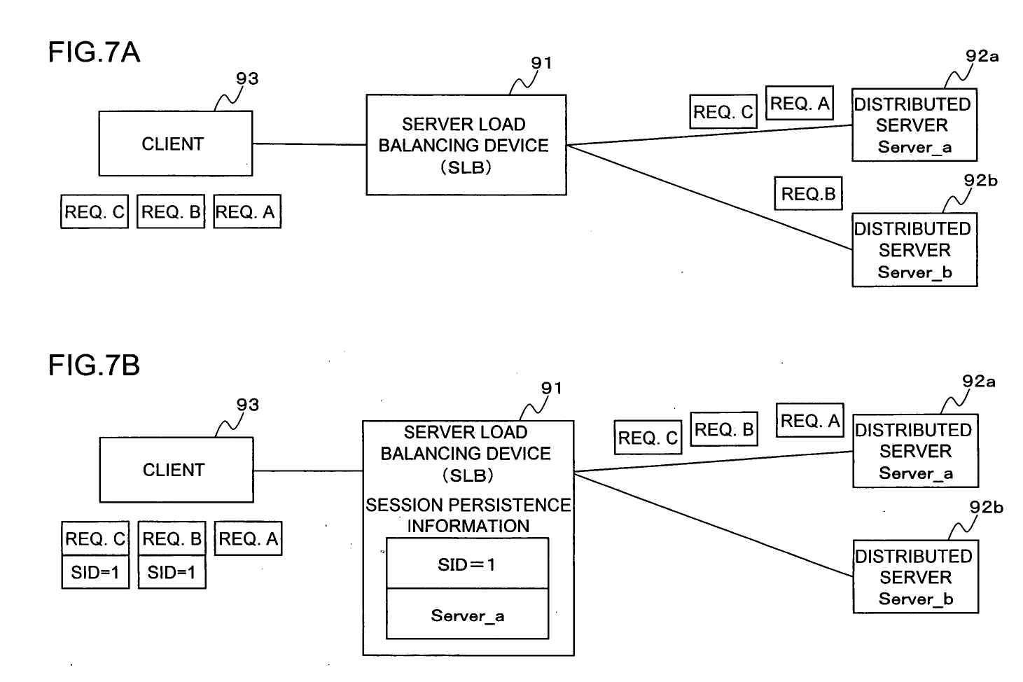

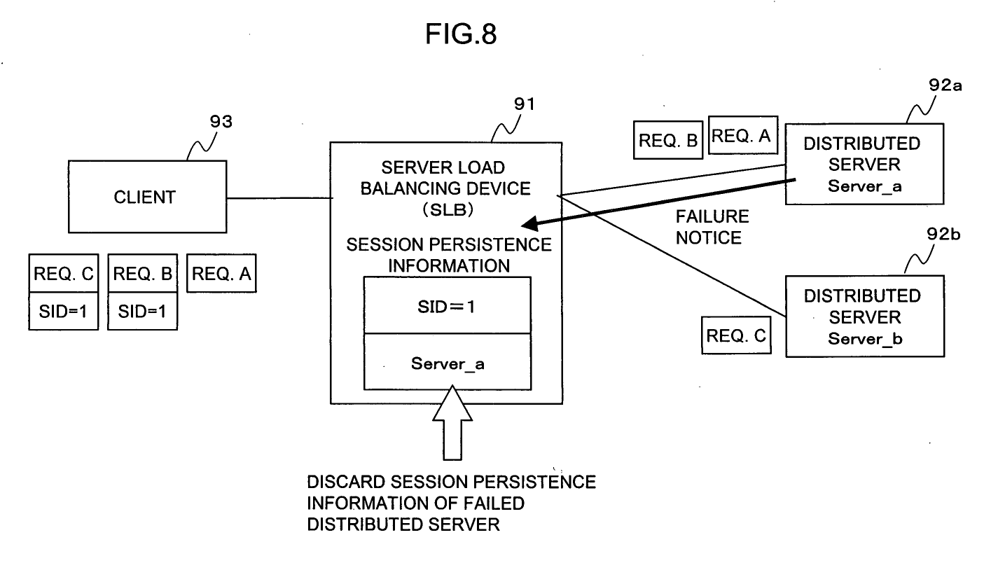

FIG. 6 shows a flow of processing performed upon inquiry about the session persistence information. When the server load balancing device 1 receives a request from the client 3a, and then notifies the distributed server failure response device 10 of the inquiry about the session persistence information in order to know whether the received request is associated with a persistent session, the session persistence information retrieving unit 15 in the distributed server failure response device 10 receives this session persistence information inquiry (step S10). The session persistence information retrieving unit 15 then searches the session persistence information storing unit 11 (step S11) to determine whether the corresponding session persistence information is stored in the session persistence information storing unit 11 (step S12). When the corresponding session persistence information is not retrieved (NO in step S12), the session persistence information retrieving unit 15 further searches the failed server session persistence information storing unit 12 (step S13) to determine whether the corresponding failed server session persistence information is stored in the failed server session persistence information storing unit 12 (step S14). When the corresponding failed server session persistence information is retrieved (YES in step S14), a service error response is generated according to service error response processing definition information which is extracted from the service error response processing definition information storing unit 13 based on the identification information (service name) set to the service error response processing of the corresponding failure server session persistence information, and the generated service error response is sent to the client 3a (step S15). On the other hand, when the corresponding failed server session persistence information is not retrieved (NO in step S14), the processing is terminated. The corresponding session persistence information is stored in the session persistence information storing unit 11 (YES in step S12), the request from the client 3a is sent to the distributed server 2a in accordance with the corresponding session persistence information (step S16).

Thus, when a failure is detected in the distributed server 2a, a sequence error response resulting from the allocation of a request in the persistent session to another distributed server 2b is not generated, thereby eliminating unnecessary processing loads both on the distributed server 2b to which a request is allocated newly and on the client 3a.

Although the present invention has been described above in the context of a preferred embodiment thereof, it should be understood that changes and modifications can be carried out without departing from the scope of the present invention.

Furthermore, although the present invention has been described as implemented as a processing program which is read and executed by a computer, the processing program for implementing the present invention can be stored in appropriate recording media, such as a portable medium memory, a semiconductor memory, and a hard disk, and is provided in the form of these recording media or provided by transmitting and receiving operations utilizing various communication networks via a communication interface.

According to the present invention, when a failure occurs in a distributed server being operative to maintain session persistence, a request unnecessary for another distributed server is no longer allocated thereto, thereby eliminating unnecessary processing loads on another distributed server which are caused due to the receipt of this unnecessary request.

Moreover, the client is never notified of a status (request abnormality) error response to a normal request, and is notified of an appropriate error response instead of this status error, thereby making it possible to eliminate unnecessary investigation works for the cause of the error.

Furthermore, according to the present invention, the error response processing can be performed according to the service error response processing definition information which is defined for each service, so that appropriate error response processing corresponding to a service executed in a failed session can be implemented.

What is claimed is:

1. A distributed server's failure response program product for processing a computer program which causes a computer to function as, during server load balancing processing for distributing client's requests to distributed servers operable as a distribution destination, session persistence maintaining processing means to allocate a series of requests within a session uniquely to a particular distributed server and responding to a failure in a distributed server associated with a session being subjected to the session persistence maintaining processing, the distributed server's failure response program product comprising the step of:
causing the computer to function as failed server session persistence information management means for, upon receipt of a distributed server's failure detection notice, extracting and deleting, from session persistence information storage means that stores session persistence information in which a session to be subjected to the session persistence maintaining processing and a distributed server allocated with the session are recorded, session persistence information of a session handled by the notified failed distributed server, then generating failed server session persistence information in accordance with the extracted session persistence information, and storing the generated failed server session persistence information in failed server session persistence information storage means;
causing the computer to function as failed server session persistence information retrieval means for, upon receipt of an inquiry request as to whether a session is subjected to the session persistence maintaining processing, retrieving session persistence information of the inquired session from the session persistence information storage means, and further retrieving failed server session persistence information of the inquired session from the failed server session persistence information storage means when the session persistence information of the inquired session is not stored in the session persistence information storage means; and
causing the computer to function as service error response processing means for executing predetermined service error response processing for a requestor client of the inquired session when the failed server session persistence information of the inquired session is extracted as a result of the retrieval of the failed server session persistence information retrieval means.

2. The distributed server's failure response program product according to claim 1, further comprising the step of:
causing the computer to function as service error response processing definition information storage means for storing, for each service executed in a session between the distributed server and a client, service error response processing definition information that defines details of the service error response processing for a failure that occurs in the distributed server during the session persistence maintaining processing for the session, wherein
when the session persistence information contains at least information for identifying a service executed in a session, the failed server session persistence information management means generates the failed server session persistence information containing the information for identifying a service in accordance with the session persistence information, and
when the failed server session persistence information of the inquired session is extracted, the service error response processing means executes the service error response processing in accordance with the service error response processing definition information corresponding to a service identified by the failed server session persistence information.

3. The distributed server's failure response program product according to claim 2, wherein the service error response processing definition information contains a definition regarding a format and response method of a response message to the client.

4. A server load balancing device executing, during server load balancing processing for distributing requests from a client to distributed servers operable as a distribution destination, session persistence maintaining processing to allocate a series of requests within a session uniquely to a particular distributed server, the server load balancing device comprising:
a session persistence information storage unit for storing session persistence information in which a session to be subjected to the session persistence maintaining processing and a distributed server allocated with the session are set;
a failed server session persistence information management unit for, upon receipt of a distributed server's failure detection notice, extracting and deleting session persistence information of a session handled by the notified failed distributed server from the session persistence information storage unit, then generating failed server session persistence information in accordance with the extracted session persistence information, and storing the generated failed server session persistence information in a failed server session persistence information storage unit;
a failed server session persistence information retrieval unit for, upon receipt of an inquiry request as to whether a session is subjected to the session persistence maintaining processing, retrieving session persistence information of the inquired session from the session persistence information storage unit, and further retrieving failed server session persistence information of the inquired session from the failed server session persistence information storage unit when the session persistence information of the inquired session is not stored in the session persistence information storage unit; and
a service error response processing unit for executing predetermined service error response processing for a requester client of the inquired session when the failed server session persistence information of the inquired session is extracted as a result of the retrieval of the failed server session persistence information retrieval unit.

5. The server load balancing device according to claim 4, further comprising:
a service error response processing definition information storage unit for storing, for each service executed in a session between the distributed server and a client, service error response processing definition information that defines details of the service error response processing for a failure that occurs in the distributed server during the session persistence maintaining processing for the session, wherein
when the session persistence information contains at least information for identifying a service executed in a session, the failed server session persistence information management unit generates the failed server session persistence information containing the information for identifying a service in accordance with the session persistence information, and
when the failed server session persistence information of the inquired session is extracted, the service error response processing unit executes the service error response processing in accordance with the service error response processing definition information corresponding to a service identified by the failed server session persistence information.

6. The server load balancing device according to claim 4, wherein the service error response processing definition information contains a definition regarding a format and response method of a response message to the client.

7. A server load balancing method for executing, during server load balancing processing for distributing requests from a client to distributed servers operable as a distribution destination, session persistence maintaining processing to allocate a series of requests within a session uniquely to a particular distributed server, the method comprising the steps of:
upon receipt of a distributed server's failure detection notice, extracting and deleting, from session persistence information storage means that stores session persistence information in which a session to be subjected to the session persistence maintaining processing and a distributed server allocated with the session are recorded, session persistence information of a session handled by the notified failed distributed server, then generating failed server session persistence information in accordance with the extracted session persistence information, and storing the generated failed server session persistence information in failed server session persistence information storage means;
upon receipt of an inquiry request as to whether a session is subjected to the session persistence maintaining processing, retrieving session persistence information of the inquired session from the session persistence information storage means, and further retrieving failed server session persistence information of the inquired session from the failed server session persistence information storage means when the session persistence information of the inquired session is not stored in the session persistence information storage means; and
executing predetermined service error response processing for a requestor client of the inquired session when the failed server session persistence information of the inquired session is extracted as a result of the step of retrieving the failed server session persistence information.

8. The server load balancing method according to claim 7, further comprising the step of:
storing, for each service executed in a session between the distributed server and a client, service error response processing definition information that defines details of the service error response processing for a failure that occurs in the distributed server during the session persistence maintaining processing for the session, wherein,
when the session persistence information contains at least information for identifying a service executed in a session, in the step of generating failed server session persistence information, generated is the failed server session persistence information containing the information for identifying a service in accordance with the session persistence information is generated, and
when the failed server session persistence information of the inquired session is extracted, in the step of executing predetermined service error response processing, executed is the service error response processing in accordance with the service error response processing definition information corresponding to a service identified by the failed server session persistence information.

9. The server load balancing method according to claim 7, wherein the service error response processing definition information contains a definition regarding a format and response method of a response message to the client.
